(19) United States
(12) Patent Application Publication
(10) Pub. No.: US 2005/0071883 A1
(43) Pub. Date: Mar. 31, 2005

(54) Remote monitoring system and method for controlling the same

(76) Inventor: Jong Sang Oh, Goonpo-si (KR)

Correspondence Address: BIRCH STEWART KOLASCH & BIRCH, PO BOX 747, FALLS CHURCH, VA, 22040-0747, US

(21) Appl. No.: 10/947,313

(22) Filed: Sep. 23, 2004

(30) Foreign Application Priority Data
Sep. 26, 2003 (KR) 10-2003-0066832

(51) Int. Cl. H04N 7/173; H04N 7/18

(52) U.S. Cl. 725/108; 348/152; 348/154; 348/153

(57) ABSTRACT

There is provided a remote monitoring system, which includes: means for recognizing a visitor; means for obtaining video/voice data from the recognized visitor; a controlling means for checking whether the visitor is an intruder on the basis of the obtained video/audio data; means for transmitting the obtained video/audio data to a security company if the visitor is an intruder. Therefore, it is possible to accurately identify an intruder using video/audio data of a visitor and swiftly take measures by adding a monitoring function to a video apparatus having a PVR function.

### BACKGROUND OF THE INVENTION

1. Field of the Invention

The present invention relates to a monitoring system, and more particularly, to a remote monitoring system for remotely monitoring an intruder using a video apparatus and a method for controlling the same.

2. Description of the Related Art

A variety of video apparatuses meeting a demand of viewers for high image quality, multi-channel and various contents have been widely distributed. Such video apparatuses include a set-top box and a digital television receiver.

The video apparatuses have a personal video recorder (PVR) with a storage medium, such as a hard disk drive (HDD), so that a user views and simultaneously stores desired video and voice data. Therefore, the user can view the stored video and voice data at a desired time.

Further, the video apparatuses have an interface unit that allows access to an external communication network. Hence, the video apparatuses can receive and store external video and voice data, or provide the stored video and voice data to the outside through the Internet network or a public switched telephone network (PSTN) using the interface unit.

In the meantime, recently, crimes such as robbery and theft rapidly increase and a security system for monitoring an intruder so as to protect a user from such crimes is widely used. Upon detection of the intruder, the security system rings an alarming siren or transmits an alarming signal to a security company so as to request a help.

However, it costs too much to install the security system. Also, since the security system merely provides an only alarming signal for an intruder to an external security company, it is difficult for the security company to accurately judge whether an intruder has really broken in using such an alarming signal only. Further, there is a problem that an erroneously provided alarming signal is unnecessarily responded to by staffs of the security company.

### SUMMARY OF THE INVENTION

Accordingly, the present invention is directed to a remote monitoring system and a method for controlling the same that substantially obviate one or more problems due to limitations and disadvantages of the related art.

An object of the present invention is to provide a remote monitoring system and a method for controlling the same, capable of accurately judging whether an intruder has broken in by providing video and voice data regarding an intruder to a security company.

Another object of the present invention is to provide a remote monitoring system and a method for controlling the same, capable of making an intruder arrested in an easy manner by storing video and audio data of the intruder.

Still another object of the present invention is to provide a remote monitoring system and a method for controlling the same, capable of defeating an intruder by providing an alarming voice stored in advance.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a remote monitoring system includes: means for recognizing a visitor; means for obtaining video and voice data of the recognized visitor; a controlling means for checking whether the visitor is an intruder on the basis of the obtained video and audio data; and means for transmitting the obtained video and audio data to a security company if the visitor is an intruder.

In another aspect of the present invention, a remote monitoring system may further include: a storage means for storing the obtained video/voice data, wherein the storage means stores in advance an alarming siren to be provided to an intruder and video/voice data of a non-intruder.

In a further another aspect of the present invention, a remote monitoring system includes: means for recognizing a visitor; means for obtaining video and voice data of the recognized visitor; and means for transmitting the obtained video and audio data to a security company.

In a further another aspect of the present invention, a remote monitoring system may further include: a storage means for storing the obtained video and audio data.

In further another aspect of the present invention, a remote monitoring system may further include: means for receiving a predetermined broadcasting signal; and means for selectively outputting the received broadcasting signal and the obtained video and voice data.

In still further another aspect of the present invention, a method for controlling a remote monitoring system includes the steps of: recognizing a visitor; obtaining and storing video and voice data regarding the recognized visitor; checking identity of the visitor on the basis of the obtained video and voice data; and if the visitor is an intruder, providing the obtained video and audio data to a security company.

In still further another aspect of the present invention, a method for controlling a remote monitoring system includes the steps of: recognizing a visitor; obtaining video and voice data regarding the recognized visitor; and storing the obtained video and voice data and providing the same to a security company.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram illustrating a construction of a remote monitoring system using a video apparatus according to an embodiment of the present invention;

FIG. 2 is a flowchart illustrating a method for controlling a remote monitoring system of FIG. 1; and

FIG. 3 is an exemplary view of a screen on which video data stored in a storage unit of FIG. 1 is displayed.

### DETAILED DESCRIPTION OF THE INVENTION

Reference will now be made in detail to the preferred embodiments of the present invention, examples of which are illustrated in the accompanying drawings.

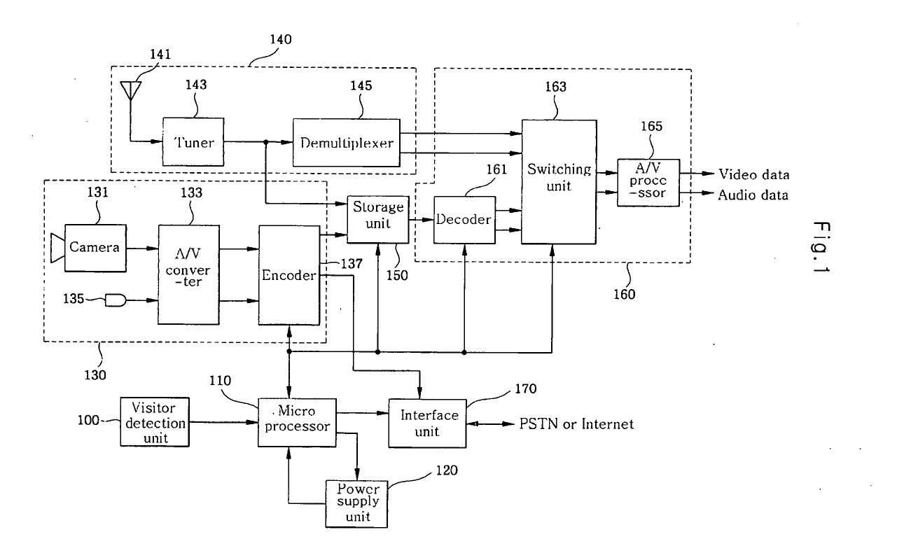

FIG. 1 is a block diagram illustrating a construction of a remote monitoring system using a video apparatus according to an embodiment of the present invention.

In FIG. 1, a remote monitoring system of the present invention is a system for monitoring an intruder using a video apparatus having a personal video recorder (PVR) function. The remote monitoring system includes a visitor detection unit 100, a microprocessor 110, a power supply unit 120, a visitor characteristics obtaining unit 130, a storage unit 150, a broadcasting signal reception unit 140, a data output unit 160, and an interface unit 170.

A viewer can watch a desired broadcasting using the broadcasting signal reception unit 140 and the data output unit 160. The broadcasting signal reception unit 140 includes a tuner 143 for receiving a broadcasting signal of a predetermined channel through an antenna 141, and a demultiplexer 145 for dividing video and voice data from the broadcasting signal received by the tuner 143. The data output unit 160 includes an audio/video (A/V) processor 165 for processing the video and audio data divided by the demultiplexer 145 and outputting the same. The tuner 143 is controlled by the microprocessor 110. That is, if a viewer selects a desired channel using an input unit, i.e., a remote controller (not shown), the microprocessor 110 controls the tuner 143 to select a channel that corresponds to the selected channel command.

In the meantime, the remote monitoring system further includes the storage unit 150 for recording/storing the broadcasting signal received by the tuner 143. The storage unit 150 is an HDD, which is used as a storage medium of the PVR. Because the storage unit 150 can store a very large capacity data, the storage unit 150 is adapted for recording/storing a broadcasting signal and monitoring an intruder as required by the present invention. The storage unit 150 is controlled by the microprocessor 110. That is, if a viewer operates the remote controller so as to watch a broadcasting signal recorded/stored in the storage unit 150, a corresponding control signal is transmitted to the microprocessor 110. Then, the microprocessor 110 reads out the broadcasting signal from the storage unit 150 and provides it to the data output unit 160 according to the control signal. Besides the A/V processor 165, the data output unit 160 further includes a decoder 161 and a switching unit 163. The decoder 161 decodes the broadcasting signal outputted from the storage unit 150, and the switching unit 163 switches video and voice data outputted from the demultiplexer 145 and video and voice data outputted from the decoder 161 under the control of the microprocessor 110. Accordingly, the viewer can watch in real-time a broadcasting signal that is currently being broadcasted and also watch at any time a broadcasting signal previously recorded/stored in the storage unit 150.

The remote monitoring system of the present invention further includes a visitor detection unit 100 and a visitor characteristics obtaining unit 130 in addition to the general video apparatus as described above, thereby capable of monitoring an intruder in real-time and taking measures in response thereto.

The visitor detection unit 100 may use a variety of sensors, such as an infrared sensor, a heat perception sensor and a temperature sensor. A person (hereinafter, referred to as a visitor) existing in a front can be recognized by these various sensors. The visitor detection unit 100 can be installed anywhere of a house that needs to be monitored. That is, the visitor detection unit 100 may be installed at a place vulnerable to an intrusion from the outside, such as a front door and a window. In case a plurality of visitor detection units 100 is installed, a position where each visitor detection unit 100 is installed may be recognized by the microprocessor 110. Therefore, a position of the visitor can be recognized.

The microprocessor 110 controls an overall operation of the remote monitoring system. That is, as described above, the microprocessor 110 controls the tuner 143 to select a broadcasting signal for a predetermined channel, controls the storage unit 150 to record/store a broadcasting signal for the channel selected by the tuner 143, and controls the switching unit 163 to selectively provide data outputted from the demultiplexer 145 or data read from the storage unit 150 and decoded by the decoder 161.

Further, if a visitor is detected by the visitor detection unit 100, the microprocessor 110 controls the power supply unit 120 to supply a power to all elements including the visitor characteristics obtaining unit 130. The microprocessor 110 and the visitor detection unit 100 are in a standby status, and the power supply unit 120 always supplies a power to the microprocessor 110 and the visitor detection unit 100. Therefore, if a visitor exists in a front, the visitor detection unit 100 always generates a detection signal for the visitor and provides the detection signal to the microprocessor 110, and the microprocessor 110 always operates to possibly recognize a visitor detected by the visitor detection unit 100.

The microprocessor 110 controls the visitor characteristics obtaining unit 130 to obtain visitor information, i.e., video and voice data of the visitor, and controls the storage unit 150 to store the obtained video and audio data of the visitor. Further, the microprocessor 110 controls the storage unit 150 to read out an alarming siren stored in advance and provide it to the visitor, and controls the interface unit 170 to provide the stored video and voice data to a security company.

The visitor characteristics obtaining unit 130 includes a camera 131 for outputting an analog video signal obtained for a visitor, a microphone 135 for outputting an analog voice signal detected for a visitor, an A/V converter 135 for converting the analog video/voice signals into a digital video/voice data, and an encoder 137 for compressing output data of the A/V converter 135 into an MPEG-2 format. The video data compressed by the encoder 137 may be moving image data or still image data. For example, in case of still image data, the encoder 137 can extract still image data by a predetermined time interval, for example, one minute.

The storage unit 150 stores video and voice data for a visitor obtained by the visitor characteristics obtaining unit 130 under control of the microprocessor 110. A predetermined alarming siren is in advance stored in the storage unit 150. The alarming siren is provided to an intruder under the control of the microprocessor 110 if the visitor is determined to be an intruder. The microprocessor 110 judges whether the visitor is an intruder using video and voice data for a visitor, stored in the storage unit 150. Video and voice data for a person (hereinafter, referred to as a non-intruder) who can be distinguished from the intruder, namely, family members, relatives, and people authenticated by a landlord, may be stored in advance in the storage unit 150. Accordingly, the microprocessor 110 judges whether the visitor is an intruder or not by comparing video data for the visitor with video data for a non-intruder stored in the storage unit 150. Further, the microprocessor 110 can judge whether the visitor is an intruder or not by comparing voice data for the visitor with voice data for the non-intruder stored in the storage unit 150.

If the visitor is judged to be an intruder, the microprocessor 110 reads out the alarming siren stored in advance in the storage unit 150 and provides the alarming siren to the visitor and controls the interface unit 170 to provide video and voice data for the visitor to a security company. Accordingly, the security company can accurately judge whether a visitor is an intruder or not using the provided video and voice data for the visitor and take appropriate measures thereto. Therefore, the present invention can solve in a definite manner a problem that an alarming siren is merely provided to a security company and the security company cannot judge whether a visitor is a real intruder.

The interface unit 170 is a terminal that can provide data transmission/reception to/from the outside and it can be connected to the Internet network or PSTN. Therefore, the security company can be provided with video and voice data for the visitor through the Internet network or the PSTN.

Further, video and voice data for a visitor, stored in the storage unit 150, can be outputted through the data output unit 160 under control of the microprocessor 110 according to a user's request. Using the data output unit 160, a user can check whether an intruder has broken in and give a help in arresting the intruder by providing the police with the above video and voice data for the visitor.

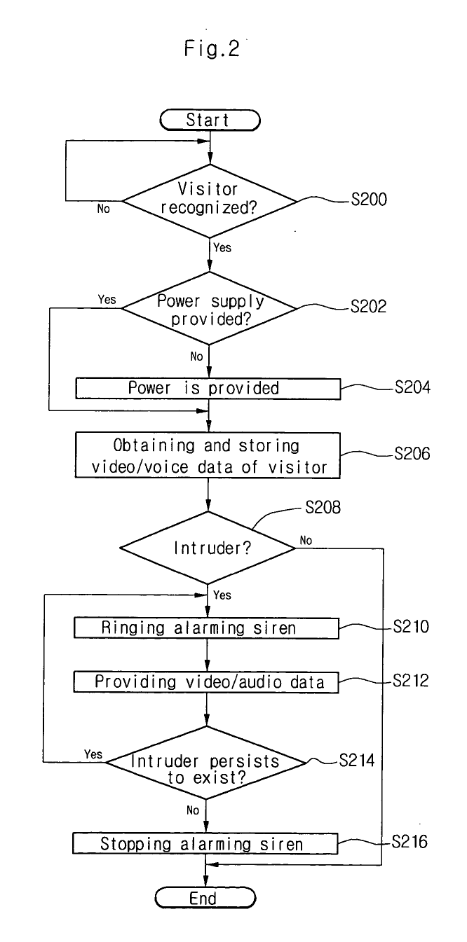

FIG. 2 is a flowchart illustrating a method for controlling the remote monitoring system of FIG. 1.

In FIG. 2, the microprocessor 110 recognizes a visitor detected by the visitor detection unit 100 (S200). If a visitor reaches a place within a predetermined distance, the visitor detection unit 100 generates a detection signal regarding the visitor and provides the detection signal to the microprocessor 110 and the microprocessor 110 recognizes the visitor based on the detection signal.

If the visitor is recognized by the visitor detection unit 100, the microprocessor 110 judges whether the power supply unit 120 supplies a power to each element (S202). If the power is not supplied to each element, the microprocessor 110 controls the power supply unit 120 to provide the power to each element (S204).

The visitor characteristics obtaining unit 130 driven by the power obtains video and voice data of the visitor and stores the data in the storage unit 150 (S206). Besides the video and voice data of the visitor, a position and an arrival time of the visitor may be additionally stored in the storage unit 150. In case a plurality of visitor detection units 100 are provided, a position of the visitor can be obtained by the visitor detection unit 100 that has detected the visitor and an arrival time of the visitor can be known by a time point when an alarming siren is provided to the visitor, which will be described later. Through such information, when and where an intruder has broken in can be known.

The microprocessor 110 judges whether the visitor is an intruder or not by comparing video and voice data of a visitor stored with video and voice data of a non-intruder stored in advance in the storage unit 150 (S208).

If the visitor is judged to be an intruder, an alarming siren stored in advance in the storage unit 150 is read out and provided to the intruder (S210).

In the meantime, when the visitor is judged to be an intruder, the microprocessor 110 controls the interface unit 170 to provide video and voice data of the visitor stored in the storage unit 150 to a security company through the Internet network or PSTN (S212). If the security company is connected through the Internet network, an Internet protocol (IP) address of the security company may be stored in the storage unit in advance, and if the security company is connected through the PSTN, a phone number of the security company may be stored in the storage unit 150 in advance. Hence, it is possible to swiftly provide video and voice data of an intruder to a security company using the stored IP address and phone number of the security company.

If the intruder is not defeated by an alarming siren and still persists to exist (S214), an alarming siren is provided constantly until the intruder goes away, and video and voice data of the intruder are constantly obtained by the visitor characteristics obtaining unit 130 and provided to the storage unit 150. The microprocessor 110 checks a time during which the alarming siren has rung constantly, i.e., an alarming time, and a time during which the video and voice data have been obtained constantly from the visitor characteristics obtaining unit 130, i.e., a recording time, and stores the same in the storage unit 150.

If the intruder goes away, an alarming siren is stopped and its operation is terminated (S216).

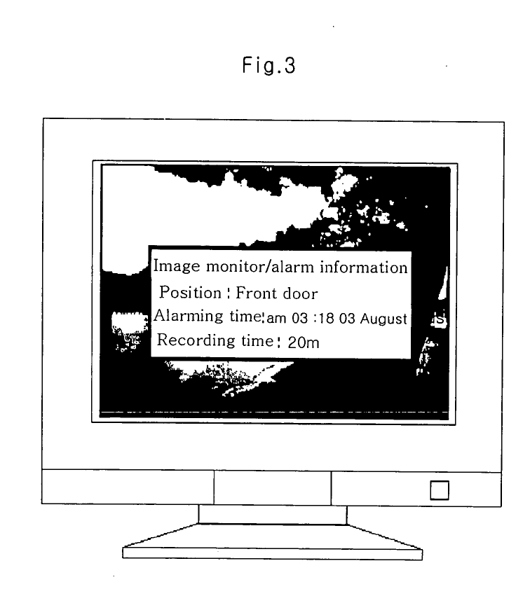

Video and voice data of a visitor, a place where a visitor has been recognized, a recording time, and an alarming time may be stored in the storage unit 150. A user, if necessary, can output and check the video and voice data of the visitor, the place where the visitor has been recognized, the recording time, the alarming time, stored in the storage unit 150, using the data output unit 160, as shown in FIG. 3.

As described above, according to the present invention, the microprocessor 110 checks whether a visitor is an intruder based on video and voice data obtained by the visitor characteristics obtaining unit 130 and if the visitor is an intruder, the microprocessor 110 provides the video and voice data of the intruder to a security company.

In the meantime, according to the present invention, it is also possible to directly provide the video and voice data obtained by the visitor characteristics obtaining unit 130 to the security company without the microprocessor's judging whether the visitor is an intruder. Of course, even in that case, an alarming siren may be provided to the relevant visitor. That is, if a visitor is recognized by the visitor detection unit 100, an alarming siren may be provided to the visitor. In that case, an alarming siren is rung for an only predetermined period of time. As described above, after an only alarming siren is provided to a visitor who is an unspecified number of the general public first, identification of the visitor may be performed by the security company. That is, whether the visitor is an intruder or not can be judged by the security company. The security company can judge whether the visitor is an intruder or not by comparing the received video and voice data of the visitor with the video and voice data of a non-intruder registered in advance, and swiftly take measures according to a result of the judgment.

As described above, the present invention can monitor an intruder using the video apparatus such as a set-top box having a PVR function or a digital television receiver and provide video and voice data of the intruder to a security company, thereby helping the security company to judge more accurately whether the visitor has broken in and take measures swiftly, and preventing the security company from being unnecessarily responded due to erroneously generated signal.

Further, the present invention can realize a remote monitoring system in a video apparatus at a low cost and output video and voice of clear and high definition quality by storing video and voice data in an HDD of a PVR. Therefore, it is possible to replay and check clear video and voice data of an intruder and contribute in identifying and arresting a suspect using analysis of voice data of an intruder.

It will be apparent to those skilled in the art that various modifications and variations can be made in the present invention. Thus, it is intended that the present invention covers the modifications and variations of this invention provided they come within the scope of the appended claims and their equivalents.

1. A remote monitoring system comprising:
means for recognizing a visitor;
means for obtaining video/voice data of the recognized visitor;
a controlling means for checking whether the visitor is an intruder on the basis of the obtained video/audio data; and
means for transmitting the obtained video/audio data to a security company if the visitor is the intruder.

2. The system according to claim 1, furthering comprising:
a storage means for storing the obtained video/voice data, wherein the storage means stores in advance an alarming siren to be provided to an intruder and video/voice data of a non-intruder.

3. The system according to claim 1, furthering comprising:
means for receiving a predetermined broadcasting signal; and
means for selectively outputting the received broadcasting signal or the obtained video/voice data.

4. The system according to claim 1, wherein whether the visitor is the intruder is determined through comparison of the obtained video/voice data of the recognized visitor with the video/voice data of the non-intruder.

5. The system according to claim 1, wherein the controlling means controls to check and store a place where an intruder has broken in, an alarming time during which an alarming siren has rung, and a recording time for constantly obtained video data.

6. The system according to claim 1, wherein a power is always supplied to the controlling means and if a visitor is recognized, a power is supplied to each means.

7. A remote monitoring system comprising:
means for recognizing a visitor;
means for obtaining video/voice data of the recognized visitor; and
means for transmitting the obtained video/audio data to a security company.

8. The system according to claim 7, further comprising a storage means for storing the obtained video/voice data.

9. The system according to claim 7, further comprising:
means for receiving a predetermined broadcasting signal; and
means for selectively outputting the received broadcasting signal and the obtained video and voice data.

10. The system according to claim 7, further comprising a controlling means for checking and storing a place where an intruder has broken in, an alarming time during which an alarming siren has rung, and a recording time for constantly obtained video data.

11. The system according to claim 7, wherein a power is always supplied to a controlling means and if a visitor is recognized, a power is supplied to each means.

12. A method for controlling a remote monitoring system, comprising the steps of:
recognizing a visitor;
obtaining and storing video/voice data regarding the recognized visitor;
checking identity of the visitor based on the obtained video/voice data; and
if the visitor is an intruder, providing the obtained video/audio data to a security company.

13. The method according to claim 12, wherein if the intruder persists to exist constantly, the video/voice data for the intruder is constantly obtained and stored.

14. A method for controlling a remote monitoring system, the method comprising the steps of:
recognizing a visitor;
obtaining video/voice data regarding the recognized visitor; and
storing the obtained video/voice data and simultaneously providing the same to a security company.
